(19) United States
(12) Patent Application Publication
(10) Pub. No.: US 2012/0054454 A1
(43) Pub. Date: Mar. 1, 2012

(54) SAMPLING FREQUENCY CONVERTER

(75) Inventor: Yasuyuki MURAKI, Hamamatsu-shi (JP)

(73) Assignee: YAMAHA CORPORATION, Hamamatsu-shi (JP)

(21) Appl. No.: 13/214,734

(22) Filed: Aug. 22, 2011

(30) Foreign Application Priority Data
Aug. 30, 2010 (JP) 2010-192064

(51) Int. Cl. G06F 12/00

(52) U.S. Cl. 711/154; 711/E12.001

(57) ABSTRACT

A sampling frequency converter has a buffer that stores data in response to a write request signal, and outputs stored data in order from the oldest data in response to a read request signal. An interpolation unit sequentially receives data from an external source, performs an interpolation operation at a generation timing of a write request signal for calculating interpolated data from a specified number of the most recently received data, and supplies the interpolated data to the buffer. A writing speed adjusting unit recurrently generates a write request signal at a time rate determined according to frequency control information. A speed correction pointer increases a pointer value each time a write request signal is generated, and decreases the pointer value each time a read request signal is generated. A frequency control unit corrects the frequency control information based on the pointer value of the speed correction pointer.

### BACKGROUND OF THE INVENTION

1. Technical Field

The present invention relates to a sampling frequency converter that is suitable for use in a digital audio device.

2. Related Art

As this kind of sampling frequency converter, there is a known converter that provides data after sampling frequency conversion to a subsequent stage device via a FIFO (First-In First-Out buffer), or there is a known converter that obtains data before sampling frequency conversion from a preceding stage device. FIG. 7 is a block diagram illustrating an example of the construction of the former sampling frequency converter, and FIG. 8 is a block diagram illustrating an example of the construction of the latter sampling frequency converter.

In the sampling frequency converter illustrated in FIG. 7, an interpolator 101 is a circuit that stores data that is sequentially received from a preceding stage device, and when a write request signal is generated, performs interpolation from a specified number of the most recent data stored up to that time in order to calculate data that corresponds to the timing for generating a write request signal, and provides the data, which is a result of interpolation, to an FIFO 102. The FIFO 102 is a buffer that stores data that is newly inputted from the interpolator 101 according to a write request signal, and sequentially reads and outputs stored data starting from the oldest data according to a read request signal from a subsequent stage device. A control unit 103 is a circuit that generates write request signals at a time rate that corresponds to frequency control information, causes the interpolator 101 to execute interpolation, and causes the FIFO 102 to store data outputted from the interpolator 101.

The control unit 103 also monitors the number of effective data, which is the number of unread data that is received from the interpolator 101 and stored in the FIFO 102 but has not yet been outputted to a subsequent stage device, and performs correction of the frequency control information based on this number of effective data. More specifically, when the speed of writing data to the FIFO 102 becomes faster than the speed of reading data from the FIFO 102, and the number of effective data increases to become greater than a specified reference value, the control unit 103 generates a negative correction value as illustrated in FIG. 9 in order to reduce the frequency control information, and lowers the speed of writing to the FIFO 102. On the other hand, when the speed of writing data to the FIFO 102 becomes less than the speed of reading data from the FIFO 102, and the number of effective data decreases to become less than a specified reference value, the control unit 103 generates a positive correction value as illustrated in FIG. 9 in order to increase the frequency control information, and increases the speed of writing to the FIFO 102. In the sampling frequency converter illustrated in FIG. 7, the sampling frequency is converted using this kind of control in which the writing speed follows the reading speed. A sampling frequency converter such as this type is disclosed in patent literature 1 for example.

In the sampling frequency converter illustrated in FIG. 8, a FIFO 104 stores data that is newly inputted from a preceding stage device according to a write request signal, and according to a read request signal, sequentially reads stored data starting from the oldest data, and outputs that data to an interpolator 105. The interpolator 105, when a read request signal is generated, obtains and stores data that was outputted from the FIFO 104, and performs interpolation from a specified number of the most recently stored data up to that time in order to calculate data that corresponds to timing for generating a read request signal, then outputs the data resulting from interpolation to a subsequent stage device. A control unit 106 generates read request signals at a time rate according to frequency control information, causes data to be outputted from the FIFO 104 to the interpolator 105 and causes the interpolator 105 to execute interpolation.

The control unit 106 also monitors the number of effective data, which is the number of unread data that is received from a preceding stage device and stored in the FIFO 104 but has not yet been outputted to a subsequent stage device, and performs correction of the frequency control information based on this number of effective data. Furthermore, as will be described in detail later, when the speed of reading data from the FIFO 104 becomes less than the speed of writing data to the FIFO 104, and the number of effective data increases to become greater than a specified reference value, the control unit 106 generates a positive correction value in order to increase the frequency control information, and increases the speed of reading from the FIFO 104. On the other hand, when the speed of reading data from the FIFO 104 becomes greater than the speed of writing data to the FIFO 104, and the number of effective data decreases to become less than a specified reference value, the control unit 106 generates a negative correction value in order to decrease the frequency control information, and reduces the speed of reading from the FIFO 104. In the sampling frequency converter illustrated in FIG. 8, the sampling frequency is converted using this kind of control in which the reading speed follows the writing speed. A sampling frequency converter such as this type is disclosed in patent literature 2 for example.
[Patent Literature 1] Japanese Patent Application Publication No. 2006-279106
[Patent Literature 2] Japanese Patent Application Publication No. 2006-238044

Incidentally, in the sampling frequency converter illustrated in FIG. 7, for example, when the speed of writing to the FIFO 102 becomes deviated by a large amount from the speed of reading, and the number of effective data becomes deviated by a large amount from the reference value, it is necessary to perform control so as to generate a correction amount having a large absolute value as illustrated in FIG. 9, and to bring the writing speed approaching the reading speed. On the other hand, in the FIFO 102, in a range where the writing speed approaches the reading speed and the number of effective data is close to the reference value, making large the slope of the change in the correction amount with respect to the change from the reference value of the number of effective data is not preferred. This is because when this slope is large, the change in the frequency control information with respect to the difference from the reference value of the number of effective data becomes large, the frequency of the write request signal becomes unstable and frequency fluctuation occurs in the data after sampling frequency conversion. Therefore, as illustrated in FIG. 9, in the area where the number of effective data is near the reference value, it is necessary to reduce the slope of the change in the correction amount with respect to the change in the number of effective data. Due to the situation described above, the writing speed is made to follow the reading speed, and in order to reduce frequency fluctuation in the data after sampling frequency conversion, it is necessary to increase the range of increasing or decreasing the number of effective data, or in other words increase the number of stages of the FIFO 102. This is also the same for the sampling frequency converter illustrated in FIG. 8.

However, in the sampling frequency converter illustrated in FIG. 7, the data that has undergone sampling frequency conversion by the interpolator 101 is sent to a subsequent stage device via the FIFO 102, and in the sampling frequency converter illustrated in FIG. 8, the data before sampling frequency conversion is sent from a preceding stage device to the interpolator 105 via the FIFO 104. Therefore, when the number of stages of the FIFO 102 or 104 is increased in order to reduce frequency fluctuation, there was a problem in that the latency from a time when a preceding stage device outputs data before sampling frequency conversion to a time when the data after sampling frequency conversion is supplied to a subsequent stage device becomes large.

### SUMMARY OF THE INVENTION

In consideration of the situation described above, the object of the present invention is to provide a sampling frequency converter that is capable of keeping frequency fluctuation of data after sampling frequency conversion low, and reducing latency of sampling frequency conversion.

A preferred form of the present invention is a sampling frequency converter, comprising: a buffer that, in response to a write request signal, stores data newly inputted to the buffer, and in response to a read request signal, reads and outputs stored data in order from the oldest one of the stored data; an interpolation unit that sequentially receives data, performs an interpolation operation at a generation timing at which a write request signal is generated for calculating interpolated data corresponding to the generation timing of the write request signal from a specified number of the most recently received data up to the generation timing of the write request signal, and supplies the interpolated data to the buffer; a writing speed adjusting unit that recurrently generates a write request signal at a time rate determined according to frequency control information, thereby causing the interpolation unit to execute the interpolation operation responsibly to the write request signal, and causing the buffer to store the data outputted from the interpolation unit responsibly to the write request signal; a speed correction pointer that increases a pointer value when a write request signal is generated, and decreases the pointer value when a read request signal is generated; and a frequency control unit that corrects the frequency control information based on the pointer value of the speed correction pointer.

With this form of the invention, control is performed such that the frequency control information is corrected according to an increase or decrease in the pointer value of the speed correction pointer, and the writing speed follows the reading speed. Therefore, adjustment of the writing speed over a wide range, and fine adjustment of the writing speed near the reading speed can be performed according to an increase or decrease in the pointer value of the speed correction pointer without increasing the number of stages of the buffer. Consequently, it is possible to reduce frequency fluctuation of data after sampling frequency conversion without latency of the sampling frequency conversion becoming large.

Another preferred form of the present invention is a sampling frequency converter, comprising: a buffer that, in response to a write request signal, stores data newly inputted to the buffer, and in response to a read request signal, reads and outputs stored data in order from the oldest one of the stored data; an interpolation unit that sequentially receives data from the buffer, performs an interpolation operation at a generation timing at which a read request signal is generated for calculating interpolated data corresponding to the generation timing of the read request signal from a specified number of the most recently received data up to the generation timing of the read request signal, and outputs the interpolated data; a reading speed adjusting unit that recurrently generates a read request signal at a time rate determined according to frequency control information, thereby causing the buffer to output data to the interpolation unit responsibly to the read request signal, and causing the interpolation unit to execute the interpolation operation responsibly to the read request signal; a speed correction pointer that increases a pointer value when a write request signal is generated, and decreases the pointer value when a read request signal is generated; and a frequency control unit that corrects the frequency control information based on the pointer value of the speed correction pointer.

With this form of the invention, control is performed such that the frequency control information is corrected according to an increase or decrease in the pointer value of the speed correction pointer, and the reading speed follows the writing speed. Therefore, adjustment of the reading speed over a wide range, and fine adjustment of the reading speed near the writing speed can be performed according to an increase or decrease in the pointer value of the speed correction pointer without increasing the number of stages of the buffer. Consequently, it is possible to reduce frequency fluctuation of data after sampling frequency conversion without latency of the sampling frequency conversion becoming large.

### BRIEF DESCRIPTION OF THE DRAWINGS

FIG. 1 is a block diagram illustrating the construction of a sampling frequency converter of a first embodiment of the present invention.

FIG. 2 is a block diagram illustrating detail construction of a 1/L down-sampler of the first embodiment.

FIG. 3 is a block diagram illustrating detail construction of a writing speed adjusting circuit of the first embodiment.

FIG. 4 is a diagram illustrating the control of a ΔT table of the first embodiment.

FIG. 5 is a time chart illustrating the operation of a write request signal generating unit of the first embodiment.

FIG. 6 is a block diagram illustrating the construction of a sampling frequency converter of a second embodiment of the present invention.

FIG. 7 is a block diagram illustrating an example of the construction of a conventional sampling frequency converter.

FIG. 8 is a block diagram illustrating another example of the construction of a conventional sampling frequency converter.

FIG. 9 is a diagram illustrating an example of the relationship between the number of effective data and the correction amount in a conventional sampling frequency converter.

### DESCRIPTION OF THE PREFERRED EMBODIMENTS

In the following, embodiments of the present invention will be explained with reference to the accompanying drawings.

### Embodiment 1

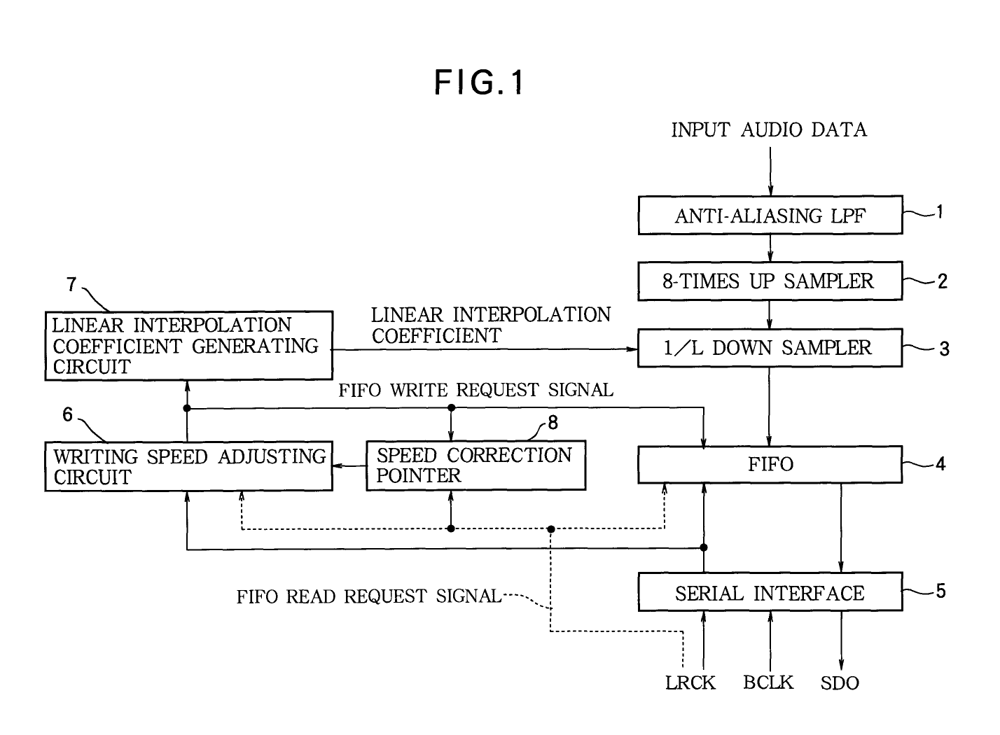

FIG. 1 is a block diagram illustrating the construction of a sampling frequency converter of a first embodiment of the present invention. In FIG. 1, an anti-aliasing LPF 1 is a circuit that performs LPF processing on input audio data in order to prevent folding noise from occurring in the sampling frequency conversion process. The sampling frequency converter of this embodiment receives input audio data having a first sampling frequency of 48 kHz, converts this data to audio data having a second sampling frequency that is selected from among nine types of sampling frequencies between 8 kHz and 48 kHz, and outputs the result. The anti-aliasing LPF 1 uses half of this selected second sampling frequency as a cutoff frequency, and removes the frequency component that is equal to or greater than this cutoff frequency from the input audio data.

An 8-times up-sampler 2 is a circuit that performs 8-times up sampling of the audio data having the first sampling frequency that is outputted from the anti-aliasing LPF 1, and outputs the result as audio data having a sampling frequency of 384 kHz. A 1/L down-sampler 3 is a circuit that uses linear interpolation to perform 1/L down sampling of the audio data having a 384 kHz sampling frequency that was outputted from the 8-time up-sampler 2, and outputs audio data having the second sampling frequency. Determining the factor at which the down sampling is performed is set according to the selected second sampling frequency.

A FIFO 4 is a first-in first-out buffer that stores the audio data having the second sampling frequency that is outputted from the 1/L down-sampler 3, and sequentially outputs the stored audio data starting from the oldest data according to a FIFO read request signal. A serial interface 5 is a circuit that performs control for supplying audio data having the second sampling frequency to a subsequent stage device. A data request signal LRCK, having the same frequency as the second sampling frequency, and a bit clock BCLK are supplied to the serial interface 5 from the subsequent stage device. After being supplied with a data request signal LRCK, the serial interface 5 supplies a FIFO read request signal to the FIFO 4 and writing speed adjusting circuit 6, converts the audio data that is outputted from the FIFO 4 to serial data SDO according to the signal LRCK, synchronizes each bit of the serial data SDO with the bit clock BCLK and supplies the result to the subsequent stage device.

A speed correction pointer 8 is a pointer that is incremented when a FIFO write request signal occurs, and is decremented when a FIFO read request signal occurs. The writing speed adjusting circuit 6 is a circuit that has the same time rate as the average time rate at which the FIFO read request signal is generated, generates a FIFO write request signal that is synchronized with a 384 kHz main clock φ, and outputs that signal to the FIFO 4 and a linear interpolation coefficient generating circuit 7. More specifically, the writing speed adjusting circuit 6 generates phase information in synchronization with the main clock φ by accumulating frequency control information according to the second sampling frequency, and every time this phase information overflows, generates a FIFO write request signal. The linear interpolation coefficient generating circuit 7 is a circuit that finds a linear interpolation coefficient from the phase information at the timing when a FIFO write request signal occurs, and supplies that coefficient to the 1/L down-sampler 3.

The writing speed adjusting circuit 6 of this embodiment has the function of correcting frequency control information according to the pointer value of the speed correction pointer 8, and adjusting the time rate or time density at which the FIFO write request signal occurs. More specifically, when the speed of writing to the FIFO 4 becomes greater than the reading speed, and the pointer value of the speed correction pointer 8 becomes greater than the reference value, the writing speed adjusting circuit 6 generates a negative correction value that decreases the frequency control information, reduces the time rate at which the write request signal is generated, and decreases the writing speed. On the other hand, when the speed of writing to the FIFO 4 becomes less than the reading speed, and the pointer value of the speed correction pointer 8 becomes less than the reference value, the writing speed adjusting circuit 6 generates a positive correction value that increases the frequency control information, increases the time rate at which the write request signal is generated, and increases the writing speed. By performing this kind of control, the writing speed follows the reading speed.

The writing speed adjusting circuit 6 of this embodiment also has a conversion table that converts the pointer value of the speed correction pointer 8 to a correction value that increases or decreases the frequency control information. In this conversion table, the slope of the change in the correction value with respect to the change in the pointer value of the speed correction pointer 8 becomes small in the region near the reference value, and as the pointer value separates from the reference value, the change in the correction value with respect to the change in the pointer value becomes large. By performing non-linear conversion using this kind of conversion table on the pointer value of the speed correction pointer 8 and generating a correction value or correction amount, a correction amount having a large absolute value is generated in the area where the speed of writing to the FIFO 4 is far deviated from the reading speed, which quickly brings the writing speed close to the reading speed, and in the area where the writing speed approaches the reading speed, a correction amount having a small absolute value is generated for correcting small shifts of the writing speed from the reading speed, thus making it possible to stabilize the writing speed and match the writing speed with the reading speed.

As described above, with this embodiment, instead of being based on the number of effective data, the speed of writing to the FIFO 4 is adjusted based on a pointer value of a speed correction pointer 8 that is incremented each time a write request signal is generated and is decremented each time a read request signal is generated. Therefore, it is possible to keep the number of stages in the FIFO 4 at the minimum number required for absorbing jitter, and latency of sampling frequency conversion can be reduced. Moreover, with this embodiment, by generating a correction amount from a pointer value of a speed correction pointer 8 using the non-linear conversion described above, in addition to adjusting the writing speed of the FIFO 4 over a wide range, it is possible to perform fine adjustment of the writing speed in a range where the writing speed is near the reading speed. Therefore, frequency fluctuation in data after sampling frequency conversion can be reduced without increasing latency of the sampling frequency conversion. Furthermore, with this embodiment, FIFO write request signals are controlled so that they are periodically generated at the same time rate as FIFO read request signals, and are generated at a timing that is synchronized with the main clock φ. Therefore, even though there may be jitter in the timing for generating the data request signal LRCK and FIFO read request signal, audio data having the second sampling frequency is generated by the 1/L down-sampler 3 and supplied to a subsequent stage device via the FIFO 4 and serial interface 5 without being affected by the jitter. The above is a summary of this embodiment.

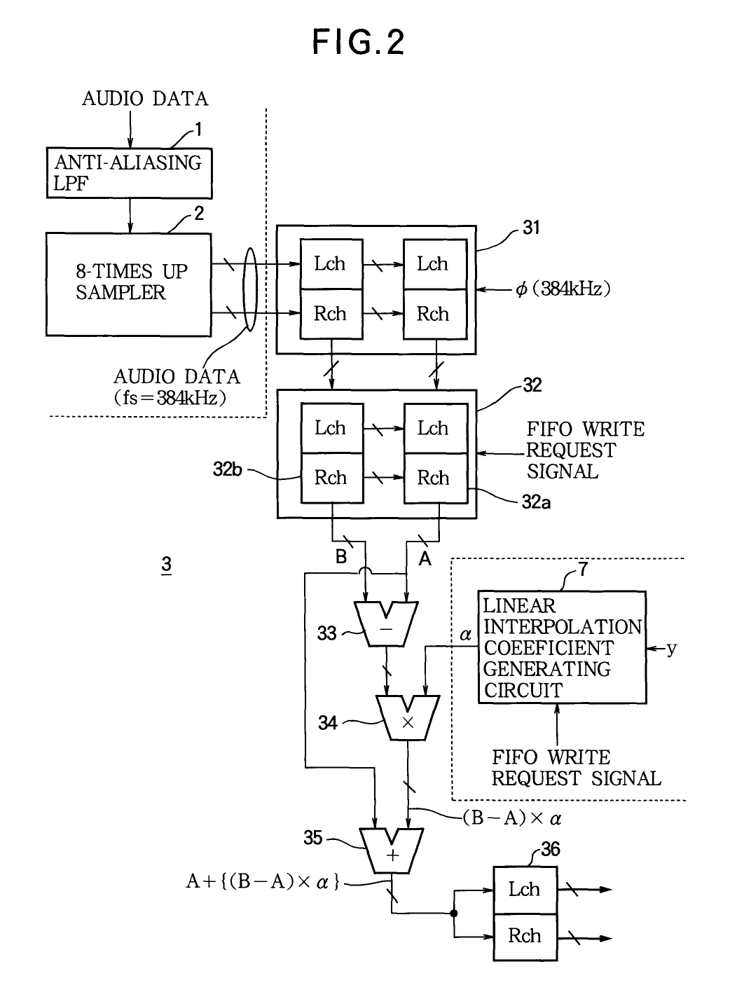

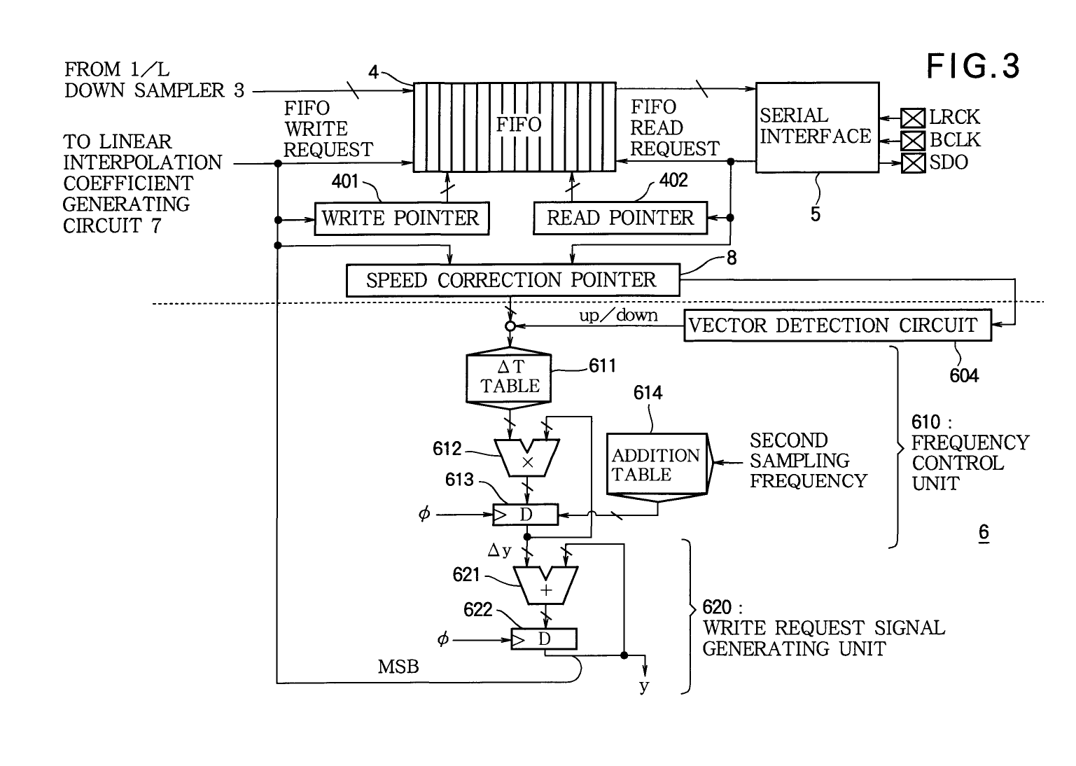

FIG. 2 is a block diagram illustrating the detail construction of the 1/L down-sampler 3 in the sampling frequency converter explained above, and FIG. 3 is a block diagram illustrating the detail construction of the writing speed adjusting circuit 6. In the following, the sampling frequency converter of this embodiment will be explained in detail with reference to these drawings.

First, the 1/L down-sampler 3 will be explained. In FIG. 2, a temporary 2-stage FIFO 31 is composed of a L-channel 2-stage FIFO and R-channel 2-stage FIFO, and every time a 384 kHz main clock φ is supplied, the temporary 2-stage FIFO 31 obtains L-channel and R-channel audio data that is outputted from the 8-times up-sampler 2, and holds the two most recent pieces of audio data for each channel. An operation data storage unit 32 is composed of registers 32a and 32b for storing audio data on both ends sandwiching an interpolation point when performing linear interpolation. When a FIFO write request signal is generated, L-channel and R-channel audio data that is stored in the second stage of the temporary 2-stage FIFO 31 is stored in register 32a, and the L-channel and R-channel audio data that is stored in the first stage is stored in register 32b. The audio data A and B that are stored in the registers 32a and 32b are used in the interpolation operation to find audio data having the second sampling frequency.

A subtractor 33, a multiplier 34, an adder 35 and a register 36 form a means for performing interpolation operation to find interpolated audio data having the second sampling frequency from the audio data A and B, and for outputting the result. Under timesharing control, and during a period from a time when a FIFO write request signal is generated until the next FIFO write request signal is generated, these circuits perform interpolation to find audio data having the second sampling frequency for each of the L channel and R channel, and supply the results to the FIFO 4 via the register 36.

More specifically, the subtractor 33 subtracts audio data A that is stored in the register 32a of the operation data storage unit 32 from audio data B of the L channel that is stored in the register 32b, and outputs the resulting data B−A. The multiplier 34 multiplies data B−A by a linear interpolation coefficient α that is outputted at that time from the linear interpolation coefficient generating circuit 7, and outputs the data (B−A)×α. Here, α is numerical value that indicates a position of audio data having the second sampling frequency that is to be found by interpolation on the time axis between audio data A and audio data B. The method used for calculating the linear interpolation coefficient α will be described later. The adder 35 adds the data (B−A)×α that is obtained from the multiplier 34 and the audio data A of the L channel that is stored in the register 32a of the operation data storage unit 32. The register 36 holds the result of adding A+(B−A)×α as the audio data of the L channel having the second sampling frequency. An example of processing by the subtractor 33, multiplier 34, adder 35 and register 36 for the L channel has been explained above, however, the same processing is executed for the audio data of the R channel, and the results are held in the register 36.

Next, the writing speed adjusting circuit 6 will be explained with reference to FIG. 3. The FIFO 4 is a 16-stage FIFO that accumulates audio data having the second sampling frequency that was generated as described above. A write pointer 401 and a read pointer 402 are connected to this FIFO 4. Here, the write pointer 401 is a circuit that increments the write address by “1” each time a FIFO write request signal is generated, and supplies the address to the FIFO 4, and at that time writes the L-channel and R-channel audio data that is supplied from the register 36 in an area that is specified by the write address in the FIFO 4. The read pointer 402 is a circuit that increments the read address by “1” each time a FIFO read request signal is generated, and supplies the address to the FIFO 4, and at that time reads L-channel and R-channel audio data from an area that is specified by the read address in the FIFO 4 and supplies that data to the serial interface 5.

A vector detection circuit 604 is a circuit that monitors the pointer value of the speed correction pointer 8, and outputs vector up/down information indicating which of the following applies to the change mode over time of the pointer value.

a. The pointer value is increasing.

b. The pointer value is decreasing.

c. The pointer value changed from increasing to decreasing.

d. The pointer value changed from decreasing to increasing.

A frequency control unit 610 provides a means for generating frequency control information Δy that sets the frequency of a FIFO write request signal. A write request signal generating unit 620 is a circuit that accumulates the total frequency control information Δy each time the main clock φ is generated, and generates a FIFO write request signal each time phase information y, which is the accumulated total value, overflows. The construction of these circuits will be described in order below.

First, the frequency control unit 610 is composed of a ΔT table 611, an adder 612, a latch 613 and an addition value table 614. The addition value table 614 stores the initial values for frequency control information Δy that is correlated with various kinds of second sampling frequencies. When the accumulation of frequency control information by the write request signal generating unit 620 is repeated in synchronization with the 384 kHz main clock φ, this frequency control information Δy takes on a value such that phase information y, which is the accumulated value, overflows at a time rate that corresponds to the second sampling frequency. More specifically, when the phase information y is taken to be a value within the range 0 to M−1, and the second sampling frequency is taken to be f2, the initial value of the frequency control information Δy is then taken to be value as given below.

$$\begin{matrix}Δ y = M / ( 384 kHz / f 2 ) \\ = M / L\end{matrix} \qquad ( 1 )$$

The latch 613 is operated such that it can be initialized. When the sampling frequency converter starts operation, the frequency control information Δy that is correlated with the second sampling frequency f2 requested by a subsequent stage device is read from the addition value table 614, and the latch 613 is initialized to that value. After that, each time the 384 kHz main clock φ is generated, the frequency control information Δy in the latch 613 is updated with the output data from the adder 612.

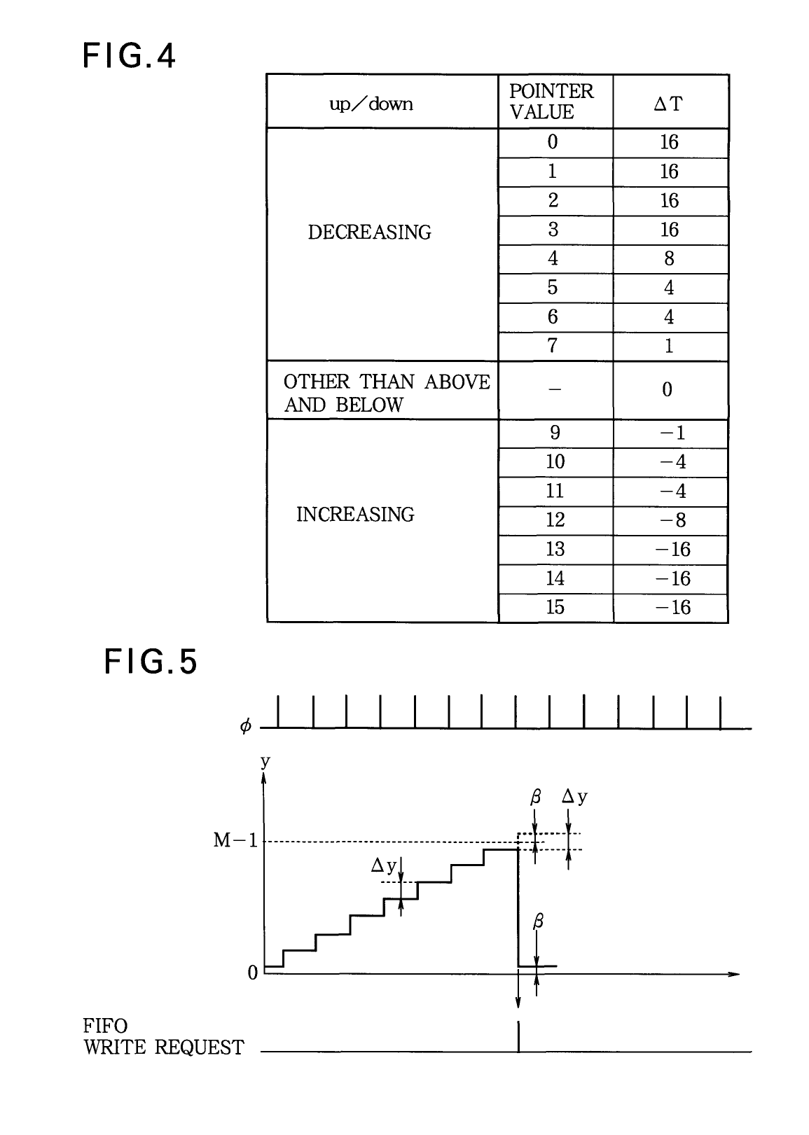

When the pointer value of the speed correction pointer 8 deviates from a reference value because the frequency control information Δy that is outputted from the latch 613 is improper, the ΔT table 611 and the adder 612 form a way of correcting the frequency control information Δy to a proper value. First, the ΔT table 611 is a table for converting the combination of the pointer value of the speed correction pointer 8 and the vector UP/DOWN to a correction amount ΔT. FIG. 4 illustrates the contents of the conversion process performed using the ΔT table 611.

As illustrated in FIG. 4, the vector UP/DOWN may indicate that the pointer value of the speed correction pointer 8 is decreasing, and when the pointer value becomes less than a reference value “8”, the ΔT table 611 outputs a positive correction amount ΔT having an absolute value that corresponds to the difference between the pointer value of the speed correction pointer 8 and the reference value “8”. As a result of the adder 612 adding this positive correction amount ΔT to the current frequency control information Δy, the frequency control information Δy increases, which causes the time rate of the FIFO write request signal to increase, and puts a brake on the decrease of the pointer value of the speed correction pointer 8. Moreover, the vector UP/DOWN may indicate that the pointer value of the speed correction pointer 8 is increasing, and when the pointer value of the speed correction pointer 8 becomes greater than the reference value “8”, the ΔT table 611 outputs a negative correction amount ΔT having an absolute value that corresponds to the difference between the pointer value of the speed correction pointer 8 and the reference value “8”. As a result of the adder 612 adding this negative correction amount ΔT to the current frequency control information Δy, the frequency control information Δy decreases, which causes the time rate of the FIFO write request signal to decrease and puts a brake on the increase of the pointer value of the speed correction pointer 8.

The write request signal generating unit 620 is composed of an adder 621 and latch 622. The adder 621 adds the frequency control information Δy that is supplied from the frequency control unit 610 and the current phase information y that is outputted from the latch 622. Each time the main clock φ is supplied, the latch 622 obtains and holds the output data from the adder 621 as new phase information y. FIG. 5 illustrates the operation of this write request signal generating unit 620. As illustrated in the FIG. 5, each time the main clock φ is generated, the phase information y is progressively increased Δy at a time. When the accumulated result of frequency control information Δy exceeds the upper limit value M−1 of the phase information y, the excess amount β is stored in the latch 622 as new phase information y. When the phase information y overflows, the MSB of the phase information in the latch 622 falls from “1” to “0”. The falling edge of the MSB is supplied to the FIFO 4, write pointer 401 and linear coefficient generating circuit 7 as a FIFO write request signal.

In FIG. 2, the linear interpolation coefficient generating circuit 7 holds the phase information y that is outputted from the latch 622, or in other words the value β illustrated in FIG. 5, at the instant that a FIFO write request signal is generated, and calculates the linear interpolation coefficient α from this value β using the following equation.

α=β/(M/L)

In this equation, the M/L value used is a value from among the initial values M/L of the frequency control information Δy stored in the addition value table 614 that corresponds to the second sampling frequency requested by a subsequent stage device.

The 1/L down sampler 3 uses the linear interpolation coefficient α that was obtained in this way to perform linear interpolation between data A and B of audio data having the second sampling frequency, and writes the audio data that is obtained from this interpolation to the FIFO 4.

With the sampling frequency converter explained above, the speed of writing to the FIFO 4 is adjusted based on the pointer value of the speed correction pointer 8 that is incremented when a FIFO write request signal is generated and is decremented when a FIFO read request signal is generated instead of the number of effective data of the FIFO 4. Therefore, control of the writing speed over a wide range, and fine adjustment of the writing speed near the reading speed can be performed according to an increase or decrease in the pointer value of the speed correction pointer 8. Therefore, the number of stages of the FIFO 4 can be set to the minimum number required to absorb jitter, and it is possible to reduce latency of sampling frequency conversion, while at the same time reduce frequency fluctuation in data after sampling frequency conversion. Moreover, with this embodiment, a FIFO write request signal having the same time rate as the average time rate of a FIFO read request signal is generated in synchronization with the main clock φ. The linear interpolation coefficient α used in the linear interpolation operation is calculated using phase information y at the timing of generating a FIFO write request signal that is synchronized with the main clock φ. Therefore, with this embodiment, even when there is jitter at the timing of generating a data request signal LRCK and FIFO read request signal, audio data having the second sampling frequency can be generated and supplied to a subsequent stage device without being affected by the jitter.

### Embodiment 2

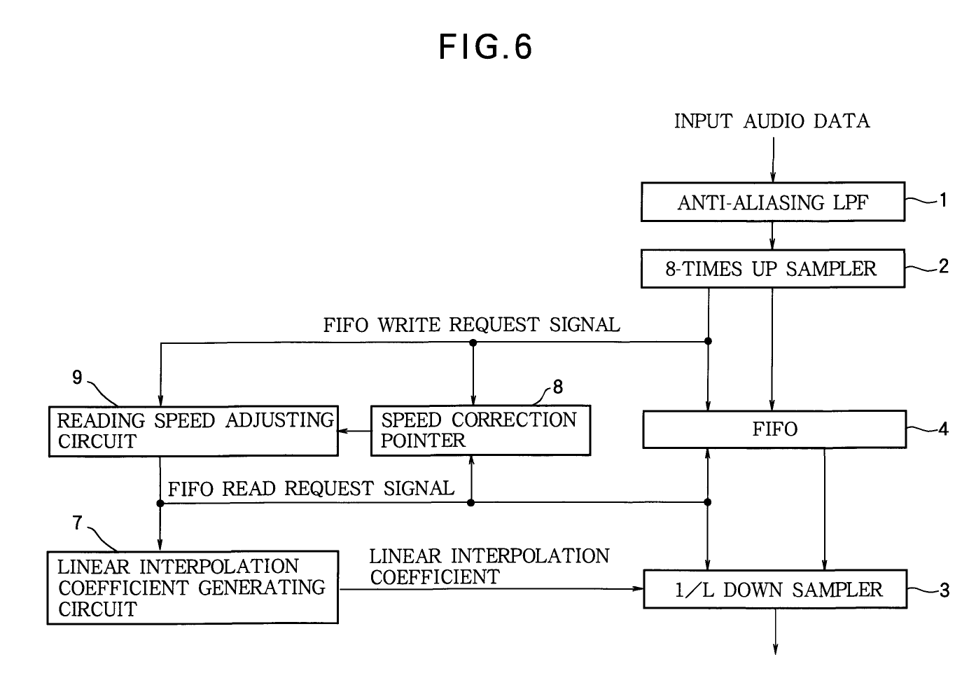

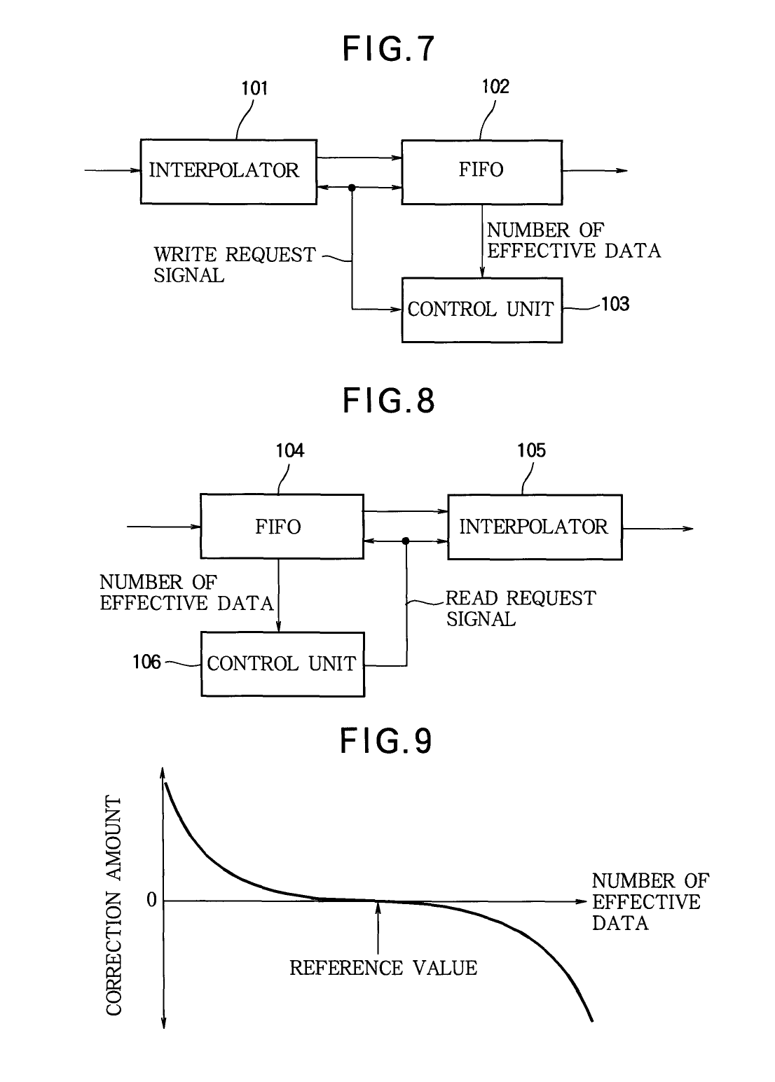

FIG. 6 is a block diagram illustrating the construction of a sampling frequency converter of a second embodiment of the present invention. In this embodiment, the construction and role of the anti-aliasing LPF 1 and 8-times up sampler 2 are the same as in the first embodiment (FIG. 1) above. In this embodiment, the positional relationship between the FIFO 4 and 1/L down sampler 3 is switched from the first embodiment.

In more detail, in response to a write request signal, the FIFO 4 stores audio data having a first sampling frequency that is outputted from the 8-times up sampler 2 and outputs the stored audio data in order starting from the oldest one. The speed correction pointer 8 is a pointer that is incremented when a FIFO write request signal is generated, and is decremented when a FIFO read request signal is generated.

A reading speed adjusting circuit 9 is a circuit that generates a FIFO read request signal that has the same time rate as the average time rate at which a FIFO write request signal is generated and that is synchronized with a 384 kHz main clock φ, and outputs that signals to the FIFO 4 and linear interpolation coefficient generating circuit 7. More specifically, the reading speed adjusting circuit 9, in synchronization with a main clock φ, generates phase information by accumulating frequency control information according to a second sampling frequency, and generates a FIFO read request signal every time that phase information overflows. A linear interpolation coefficient generating circuit 7 then finds a linear interpolation coefficient from the phase information at the timing of generating the FIFO read request signal, and supplies the coefficient to the 1/L down sampler 3.

The reading speed adjusting circuit 9 of this embodiment has a function of increasing or decreasing frequency control information according to the pointer value of a speed correction pointer 8, and adjusting the time rate or time density at which FIFO read request signals are generated. In more detail, when the speed of reading from the FIFO 4 becomes greater than the writing speed, and the pointer value of the speed correction pointer 8 becomes less than a reference value, the reading speed adjusting circuit 9 generates a negative correction amount that decreases the frequency control information, which decreases the time rate at which read request signals are generated, and reduces the reading speed. On the other hand, when the speed of reading from the FIFO 4 becomes less than the writing speed, and the pointer value of the speed correction pointer 8 becomes greater than a reference value, the reading speed adjusting circuit 9 generates a positive correction amount that increases the frequency control information, which increases the time rate at which read request signals are generated, and increases the reading speed. With this kind of control, the reading speed follows the writing speed.

Moreover, the reading speed adjusting circuit 9 of this embodiment has a conversion table that converts the pointer value of the speed correction pointer 8 to a correction amount that increases or decreases the frequency control information. As in the first embodiment above, in this conversion table the slope of the change in the correction amount with respect to the change in the pointer value of the speed correction pointer 8 is small near the reference value, and as the pointer value separates away from the reference value, the slope of the change in the correction amount with respect to the change in the pointer value of the speed correction pointer 8 become large. Therefore, with this embodiment, in the area where the speed of reading from the FIFO 4 is separated away from the writing speed, a correction amount having a large absolute value is generated, which causes the reading speed to quickly approach the writing speed, and in the area where the reading speed is near the writing speed, a correction amount having a small absolute value is generated for the small deviation of the reading speed from the writing speed, which can stabilize the reading speed and cause the reading speed to match the writing speed.

Therefore, with this embodiment, the same effect as in the first embodiment can be obtained.

First and second embodiments of the present invention were explained above, however, in addition to these embodiments, other embodiments are possible for the present invention. For example, in each of the embodiments above, 8-times up sampling was performed for input audio data having a first sampling frequency, and after being converted to 384 kHz audio data, audio data having a second sampling frequency was generated by performing 1/L down sampling, however, instead of performing 8-times up sampling, it is possible to perform high-order interpolation as 1/L down sampling.

What is claimed is:

1. A sampling frequency converter, comprising:
a buffer that, in response to a write request signal, stores data newly inputted to the buffer, and in response to a read request signal, reads and outputs stored data in order from the oldest one of the stored data;
an interpolation unit that sequentially receives data, performs an interpolation operation at a generation timing at which a write request signal is generated for calculating interpolated data corresponding to the generation timing of the write request signal from a specified number of the most recently received data up to the generation timing of the write request signal, and supplies the interpolated data to the buffer;
a writing speed adjusting unit that recurrently generates a write request signal at a time rate determined according to frequency control information, thereby causing the interpolation unit to execute the interpolation operation responsibly to the write request signal, and causing the buffer to store the data outputted from the interpolation unit responsibly to the write request signal;
a speed correction pointer that increases a pointer value when a write request signal is generated, and decreases the pointer value when a read request signal is generated; and
a frequency control unit that corrects the frequency control information based on the pointer value of the speed correction pointer.

2. The sampling frequency converter according to claim 1, wherein the frequency control unit comprises a conversion unit that converts the pointer value of the speed correction pointer to a correction value for increasing or decreasing the frequency control information in nonlinear manner such that a slope of change in the correction value is small near a reference value and becomes larger going away from the reference value.

3. A sampling frequency converter, comprising:
a buffer that, in response to a write request signal, stores data newly inputted to the buffer, and in response to a read request signal, reads and outputs stored data in order from the oldest one of the stored data;
an interpolation unit that sequentially receives data from the buffer, performs an interpolation operation at a generation timing at which a read request signal is generated for calculating interpolated data corresponding to the generation timing of the read request signal from a specified number of the most recently received data up to the generation timing of the read request signal, and outputs the interpolated data;
a reading speed adjusting unit that recurrently generates a read request signal at a time rate determined according to frequency control information, thereby causing the buffer to output data to the interpolation unit responsibly to the read request signal, and causing the interpolation unit to execute the interpolation operation responsibly to the read request signal;
a speed correction pointer that increases a pointer value when a write request signal is generated, and decreases the pointer value when a read request signal is generated; and
a frequency control unit that corrects the frequency control information based on the pointer value of the speed correction pointer.

4. The sampling frequency converter according to claim 3, wherein the frequency control unit comprises a conversion unit that converts the pointer value of the speed correction pointer to a correction value for increasing or decreasing the frequency control information in nonlinear manner such that a slope of change in the correction value is small near a reference value and becomes larger going away from the reference value.
